(19) United States
(12) Patent Application Publication
(10) Pub. No.: US 2003/0098795 A1
(43) Pub. Date: May 29, 2003

(54) Method and apparatus for temporarily incapacitating a malfeasant and others in a relatively confined space

(76) Inventor: Michael Marcos, Houston, TX (US)

Correspondence Address: MICHAEL L. PARKS, Suite 211, 3131 West Alabama, Houston, TX, 77098, US

(21) Appl. No.: 10/001,169

(22) Filed: Nov. 28, 2001

(51) Int. Cl. G08B 13/00

(52) U.S. Cl. 340/574; 340/573.1; 340/573.4

(57) ABSTRACT

A method and apparatus for temporarily incapacitating a malfeasant and others located in a relatively confined space of relatively known volume comprising, holding an incapacitant substance, moving the incapacitant substance from a tank by a pump to a vaporizer for vaporization of the incapacitant substance, mixing the vaporized incapacitant substance with a gas such as air in a relatively confined space of relatively known volume, monitoring the concentration of the incapacitant substance and gas mixture and controlling the rate of vaporization in response to the monitored concentration to reach a concentration sufficient for a given incapacitant substance to incapacitate a malfeasant and others located in the relatively confined space of a relatively known volume, and sensors for sensing and giving read out of the concentration of the incapacitant substance over a time period sufficient to incapacitate a malfeasant and others located in the relatively confined space of know volume.

### BACKGROUND OF THE INVENTION

This invention relates generally to methods and apparatus for temporarily incapacitating a malfeasant or malfeasants, such as hijackers, and others, such as passengers, located in a relatively confined space of relatively known volume, such as an aircraft cabin. Specifically this invention provides an incapacitate substance, such as anesthetic, which may be moved from a tank by a pump to a vaporizer for vaporization once the operator, such as a pilot, determines that a malfeasant or malfeasants have become active to incapacitate the malfeasants and passengers temporarily until the operators can restrain the incapacitated malfeasant or malfeasants without putting the air craft, or others at risk from injury.

Since the acts of terror by malfeasants who are mixed in with others whether in air planes, prisons, financial institutions, etc are on the rise, there have been many ways devised to control and neutralize the malfeasants with as little harm to others as possible, but they have all been relatively dangerous to date for the others and subject the space where they were located to great damage. In the case of an airplane, it could put not only the plane at risk to damage, but also structures and other people on the ground in danger, as in the case of the World Trade Center buildings.

In the case of air planes there have been many different strategies developed to incapacitate the malfeasant, such as terrorist, but many have relied upon the use of firearms and the skill of the shooter to incapacitate a malfeasant. Also the shooter may not only incapacitate a malfeasant, but also kill or wound other passengers in the process of incapacitating the malfeasant. Further if the shot goes wild it can even penetrate the airplane cabin and cause the loss of pressure or other damage to the plane which could cause the plane to crash. Also in the case of hijackers they have been known to work in groups and not all groups become active malfeasants at once and the second group of hijackers may take the shooter by surprise once he has identified himself by shooting the first group of hijackers. If this event happens the firearm may even then fall into the hands of the terrorist.

While the prior art has attempted to provide means like air marshals to incapacitate malfeasants, this is very expensive and is only effect when there are air marshals on very flight and generally there will be a need for at least two to be fully effective against possible teams of terrorists.

Also in the case of airplanes it has been proposed to secure the cockpit so that no matter what happens in the passenger cabin the pilots can continue to control the airplane and fly it to a safe landing. This theory is designed to deprive the hijackers of access to the plane which thus prevents the plane from being used as a weapon of mass destruction. That approach may in theory preserve the plane from being used as a weapon, but it may mean that the passengers would be killed one at a time by the hijackers in an attempt to cause the pilots to open the door of the cockpit in a effort to save his passengers or a member of his crew.

Another situation which is possible in the terrorist environment in which air lines operate these day is the possibility that a terrorist, will smuggle a bomb on board and his co-conspirators would bring the pieces necessary for a trigger of the bomb and they may assemble the bomb on board and then threaten to blow up the plane unless it is turned over to them. Clearly firearms and other means of constrain would not be effective against this type of malfeasant attack because unless the malfeasant is killed on the first shot he could still detonate the bomb any way.

Further approaches have suggest the use of mace or other hand held chemical weapons to incapacitate the malfeasants, but in each such case it may be difficult to effectively deploy and may subject the other passengers to potential harm with the very weapons designed to incapacitate the malfeasants. Also these weapons may not be sufficiently strong and broadly applied to get all the malfeasants on the airplane and then the malfeasants or second team might have a chance to catch the pilot and crew off guard and then take over the plane after it appears that the first group of malfeasants is under control.

There have also been proposals to use other chemicals to control the malfeasants, but many of these chemicals are flammable and provide the risk of starting a fire on board the air craft, which could destroy the plane and all on board. Further some of these chemicals are very corrosive and if injected into the cabin could do both short term damage to the air craft and more insidiously could do long term damage which might cause the plane or it controls to fail at a later time.

Also the incapacitation of malfeasants is not limited to just air planes, but has application in financial institutions where such malfeasants as bank robbers may attempt to hold up a bank or hold customers hostage in the bank. These situations provide some of the same potential problems of harm to the customers or bank personnel by the bank robbers that exist to passengers. Further in these situations, if they become a stand off with the police, then these situations can create great damage to occur to the bank facilities as well as loss of life.

In the case of prison riots, there are always those who are malfeasants and other inmates who are not active participants, but it is difficult to tell the malfeasants from the others and in the process of controlling the situation, those others may be killed or injured. Also there is the problem of hostages being taken, such as the guards, and in these situations in the process of suppressing the riot, they may be killed before the situation can be brought under control. Further when the use of chemical agents in the prison situation occur it generally gives the malfeasant a warning that a storming or some suppression action is about to occur and at these critical times many violent acts may occur in desperation by the malfeasants.

The prior art has attempted in many ways to suppress and contain malfeasants with out injury to others and to the relatively confined space. Generally taking action against a malfeasant in the relatively confined space of a relatively known volume, without having others harmed, in has met with only limited success or results without creating greater harm and damage in the process.

### OBJECTS OF THE INVENTION

It is the object of this invention to provide apparatus and methods of using this apparatus for temporarily incapacitating a malfeasant and others located in a relatively confined space of relatively known volume while causing as little injury to the others and the space they are located in as possible until the malfeasants have been fully restrained. One of the benefits of this invention is that it can be applied in many situations where there is a relatively confined space of relatively known volume while causing little injury whether it is an airplane, prison, bank lobby, or other location.

Also an object of this invention is to incapacitate the malfeasant without the malfeasant becoming aware that he is being incapacitated which will prevent them from taking any revengeful action because they are being incapacitate.

It is further an object of this invention to prevent the malfeasant from injuring the others in the common space of relatively known volume while at the same time temporarily incapacitating the malfeasant and in the process the others also.

Yet a further object of this invention is to temporarily incapacitate all the malfeasants and the others in the common relatively confined space of relatively known volume until it can be fully determine who is a malfeasant and who may be considered the others. This determination being with superior forces present and in a controlled environment once the incapacitant substance has worn off.

A further object of this invention is to incapacitate a malfeasant with out having to use a fire arm or deadly force which may kill or injure others but in addition may, in the case of an air plane damage the plane and cause a crash.

An object which is also important in this invention is the elimination of an air Marshall or more than one on every flight to have effective malfeasant prevention because this invention may be activated by the pilot who is already present flying the plane.

Also it is an object of this invention to provide an inexpensive and effective method and apparatus for the incapacitation of a malfeasant or malfeasants with out injury to the others and the plane or the relatively confined space of relatively known volume in which the malfeasant and the others are located.

This invention further provides an incompacitant substance for the incapacitation of malfeasants and others without introducing flammable substances into the relatively confined space of relatively known volume which could be capable of ignition or explosion in the relatively confined space.

Yet further an object of this invention is to provide an incapacitant substance which is not corrosive or harmful to the relatively confined space and in the case of air plane the operating equipment of the plane itself and at the same time be effective against the malfeasants and others in the relatively confined space, so that there will be no future harm caused to the air plane.

Broadly it is an object of this invention to provide an incapacitant substance which can be used in prison situations or hostages situations to prevent injury to others who are not active malfeasant in the situation in the relatively confined space of a relatively known volume.

Yet further and additional benefits and improvements of this invention will be appreciated by other skilled in the art and those advantages and benefits of this invention will become evident to those skilled in the art upon a reading and understanding of the following detailed descriptions.

### BRIEF DESCRIPTIONS OF THE DRAWINGS

This invention may be practiced in certain physical forms, arrangements, and methods from the parts herein described without departing from the concept of this invention, but a preferred embodiment of which will be described in the specification and illustrated in the accompanying drawings which form a part hereof is set out below.

FIG. 1 is a diagrammatic view of the apparatus used to perform the method of this invention for temporarily incapacitating a malfeasant and others located in a relatively confined space of relatively known volume and of the instrumentation used to monitor and control this invention.

FIG. 2 is a diagrammatic view of one embodiment of the apparatus used to perform the method of this invention for temporarily incapacitating a malfeasant and others located in a relatively confined space of relatively known volume with a blower for rapidly mixing of incapacitant substances and gas, which in this case is air. The instrumentation shown in FIG. 2 is similar to that in FIG. 1 and carries the same reference numbers.

FIG. 3 is a diagrammatic view of one embodiment of the apparatus used to perform the method of this invention for temporarily incapacitating a malfeasant and others located in a relatively confined space of relatively known volume with an inlet valve for feeding gas to a chamber for providing vaporization and rapid mixing of incapacitant and gas, in this case is air. The instrumentation shown in FIG. 3 is similar to that in FIG. 1 and carries the same reference numbers.

FIG. 4 is a diagrammatic view of one embodiment of the apparatus used to perform the method of this invention for temporarily incapacitating a malfeasant and other located in a relatively confined space of relatively known volume with an oxygen generator used to provide oxygen gas for vaporization and mixing of incapacitant and gas, in this case oxygen, with the other gas, in this case air, present in the relatively confined space having a relatively known volume. The instrumentation shown in FIG. 4 is similar to that in FIG. 1 and carries the same reference numbers.

### DESCRIPTION OF PREFERRED EMBODIMENT

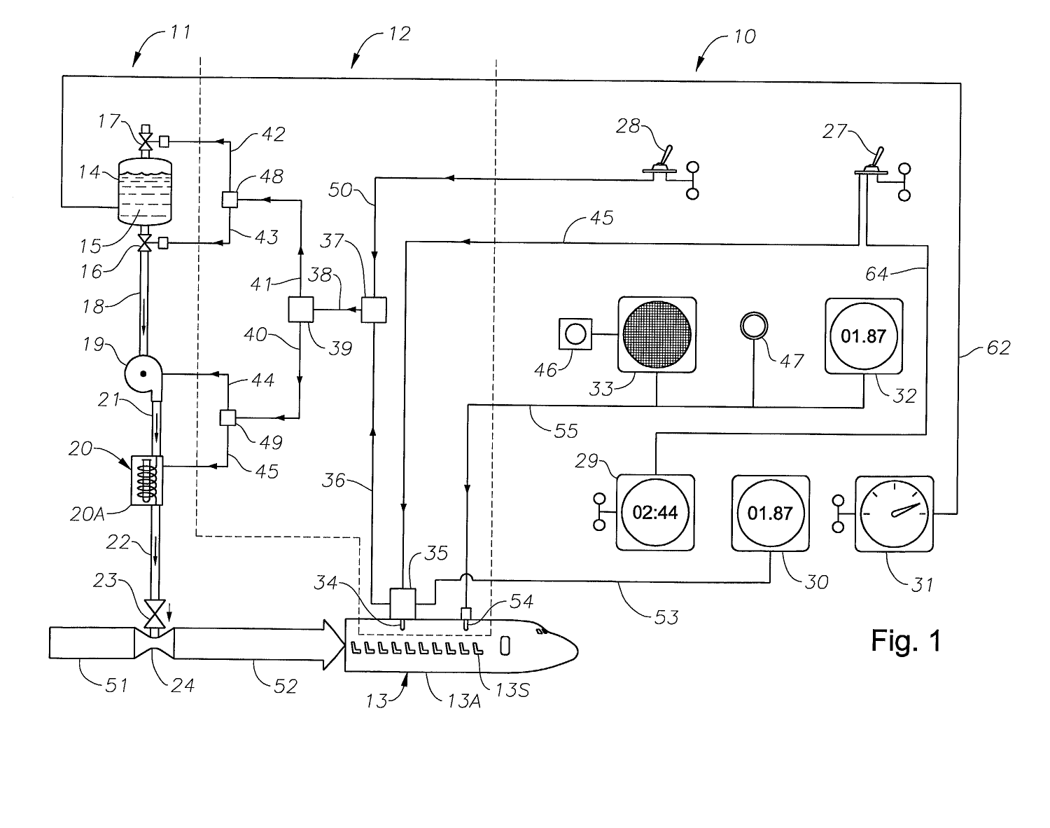

Referring now to the drawings of FIG. 1 wherein one embodiment of this invention is shown generally in three areas, which have been generally demarcated only for clarity by dashed lines, with one area being the instrumentation panel at general reference number 10, another being the operational apparatus at general reference number 11, and the third the sensor and controller interfaces at general reference 12. This invention can probably best be understood by first describing the apparatus of one embodiment and then relating a method embodiment as might be practiced with that one apparatus embodiment.

To better understand this invention refer to the reference number of the operational apparatus 11 which shows generally a relatively confined space 13 of relatively known volume, which could be more specifically identified as an air craft cabin 13A in which a malfeasant and others might be seated in seats 13S. It should be understood that at the first seating all the members in the relatively confined space 13 or air craft cabin 13A would generally be considered others, but if some of those others become malfeasants or air plane hijackers, the apparatus of this invention would be activated to incapacitate the declared malfeasant or malfeasants and the others for protection of the air plane.

As will be come apparent, an aircraft cabin 13A is a relatively confined space 13 for which there is a relatively known volume of a gas, which in this case is air. It will also be obvious that the volume of gas or air for any given air plane may vary, but at least for a given model of air craft the relative space and relative volume would be know or easily calculated. As those skilled in the art will know, the relative volume of the particular air plane will be slightly greater than the relative confined space 13 of an air craft cabin 13A of the air plane because of the air circulating system. This slightly greater volume occurs, because in an air plane, the air conditioning system adds some fresh air to the relatively confined space 13 to keep the air fresh and discharges some of the old air in the relatively confined space of the air craft cabin 13A, therefore this loss of air and the fresh make up air should make up part of the relatively known volume of gas in the relatively confined space 13 during the time necessary to incapacitate the malfeasant. The significants of why this make up air needs to be included in the volume of the relatively confined space 13 will be more fully explained later herein.

In one embodiment of this invention practiced in airplanes there would be a tank 14 mounted in the aircraft for holding an incapacitant substance 15, such as an aesthetic. The tank 14 would have at least one discharge valve 16 provided to the tank 14 for discharging the incapacitant substance 15 from the tank 14. It should be understood by those skilled in the art that if the incapacitant substance 15 in the tank 14 is a liquid at relatively ambient pressure then a vent actuator valve 17 would also be located on the tank 14 to allow ambient air inflow for allowing the easy discharge of the incapacitant substance 15 from the tank 14 without creating a back pressure in the tank which might prevent the flow of the incapacitant substance 15 from the tank 14. However, if the incapacitant substance 15 is maintained under pressure then a vent actuator valve 17 may not be necessary to prevent a back pressure from forming in the tank 14 as the incapacitant substance 17 is removed from the tank 14. Which of these two approaches to be used with either ambient pressure or high pressure incapacitant substance 15, would be a designer's choice depending on the particular application for which one might have a need to practice this invention.

The at least one discharge valve 16 on the tank 14 would then be connected by conduit 18 in fluid communication with a pump member 19 for moving the incapacitant substance 15 from the tank 14 to the pump member 19. The pump member 19 would discharge into a conduit 21 which is connected to a state converter, generally referred to as 20, down stream from the pump member 19. The state converter 20, as those skilled in the art will appreciate may be any device which converts a liquid to a gaseous state or takes a gas from a compressed state to a gaseous state without freezing up, but the state converter 20 as shown in FIG. 1 is a heat activated vaporizer 20A. Thus the incapacitant substance 15 would be moved out of the tank 14 and delivered to the state converter 20 at a relatively controlled and constant pressure by the pump member 19 to allow the state converter 20 to operate in a controlled manner for converting the incapacitant substance 15 into a state to be air borne. In some applications the air borne incapacitant substance 15 would be discharged into the relatively confined space 13 by way of a conduit 22 connected between the state converter 20 and the relatively confined space 13. The air borne incapacitant substance 15 discharged into a conduit 22 in some applications will be passed through a one way flow valve 23 located in the conduit 22. The reason the air borne incapacitant substance 15 is passed through a one way flow valve 23 is because it is important to maintain exacting control of the concentration and location of the incapacitant substance 15 in the relatively confined space 13 and to know its presence and keep it out of the spaces adjacent the relatively confined space 13, as will be more fully explained later herein.

In some applications the discharge from the one way flow valve 23 may be directly into relatively confined space 13, but as shown in FIG. 1, it discharges into a mixing chamber 24 and then into a duct 52 before being delivered into the relatively confined space 13. The one way flow valve 23 in this configuration is connected to a mixing chamber 24 for the precise delivery of the incapacitant substance 15 and for allowing rapid mixing of the incapacitant substance 15 as it is discharged out of mixing chamber 24 through the duct 52 into the relatively confined space 13. The one way flow valve 23 assists in the control of the incapacitant substance 15 in spaces not within the relatively confined space 13, because the one way valve 23 will remain closed until the one way flow valve 23 has a positive pressure exerted on it.

The mixing chamber 24 may be of a venture type for rapid mixing of the air borne incapacitant substance 15 with the gas from a main air conditioning duct 51 of the air craft, which in that case is air, and for distribution of the air borne incapacitant substance 15 and gas in relatively diluted concentrations through the duct 52 into the relatively confined space 13, or an air craft cabin 13A where malfeasants or other are located in air craft seats 13S. While it is desirable to reach as quickly as possible an effective concentration of the incapacitant substance 15 and gas, such as air, in the relatively confined space 13 with relatively known volume, it is generally undesirable to discharge the concentrated air borne incapacitant substance 15 directly in to the relatively confined space 13 because incapacitant substances 15 may be harmful or even deadly in concentrations which are too high. Thus the mixing in the mixing chamber 24 and duct 52, in at least this embodiment, allows the incapacitant substance 15 to be diluted toward a safe but high concentration level before being injected through duct 52 into the relatively confined space 13, which allows the reaching of the desired concentration level at a rapid rate for the incapacitation of the malfeasant and others in the relatively confined space 13 of relatively known volume,

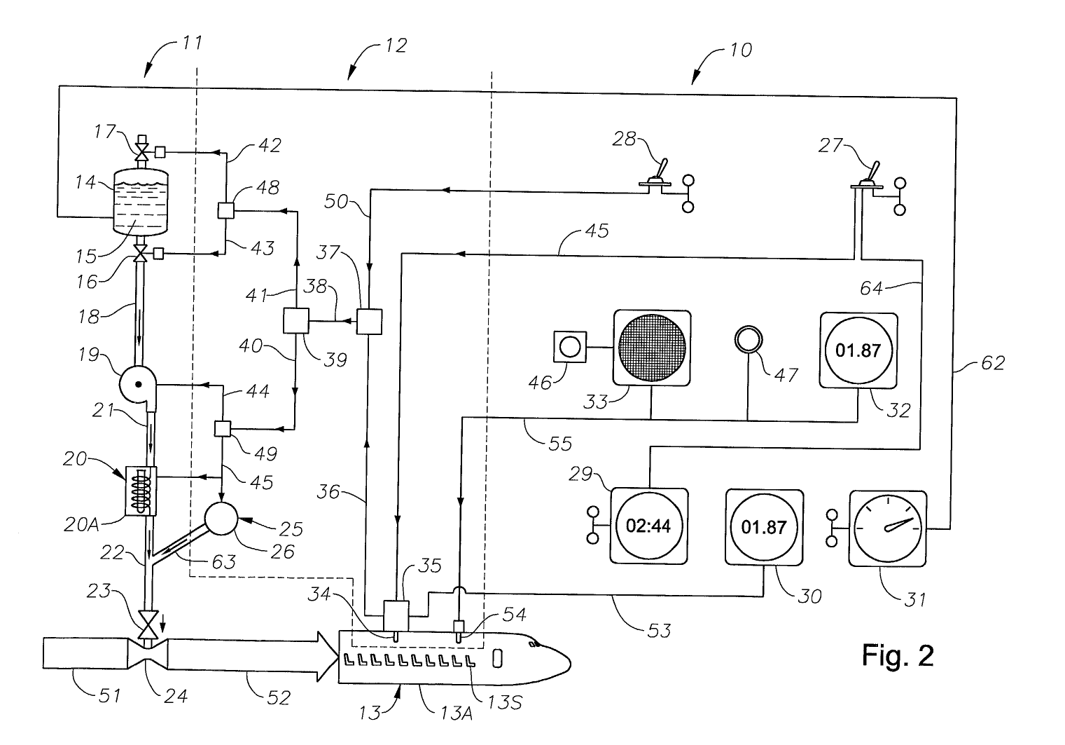

To achieve an even higher level of mixing of the incapacitant substance 15, in some embodiments, generally a forced gas member 25, as shown in FIG. 2, such as a powered blower 26 may be provided. The power blower 26 is connected in fluid communication by a conduit 63 to conduit 22 for increased the mixing of the incapacitant substance 15 in the conduit 22 as it driven through the one way flow valve 23 into the mixing chamber 24. This forced gas member 25, such as the powered blower 26, also assists in giving added pressure in the conduit 22 which feeds to the one way flow valve 21 to give added positive pressure to the one way flow valve 21 to open when the powered blower 26 is turned on and positive closing of the one way flow valve 21 when the powered blower 26 is turned off.

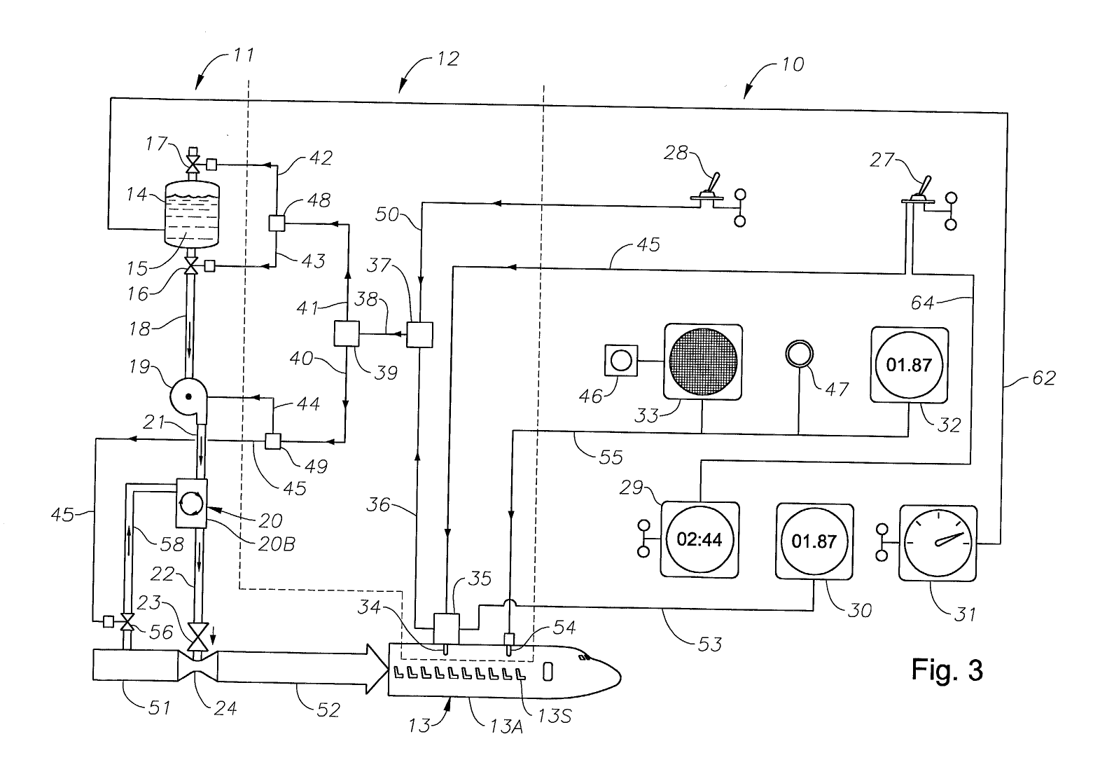

In yet other ways of mixing and vaporizing incapacitant substance 15 reference may be had to FIG. 3 where an intake valve 56 is connected to the main air conditioning duct 51. In this embodiment upon intake valve 56 being opened by in put over line 45 duct 58 begins to receive gas, which in this case is air, into the duct 58 which feeds into the state converter 20. The state converter 20 in this case may be a gas activated vaporizer 20B which uses the accelerated air flow from the air conditioning duct 51 to vaporize the incapacitant substance 15 for deliver to conduit 22 which then feeds to the one way flow valve 23 and the mixing chamber 24 for delivery into the relatively confined space 13 of relatively known volume by way of duct 52 for the incapacitation of malfeasant and others.

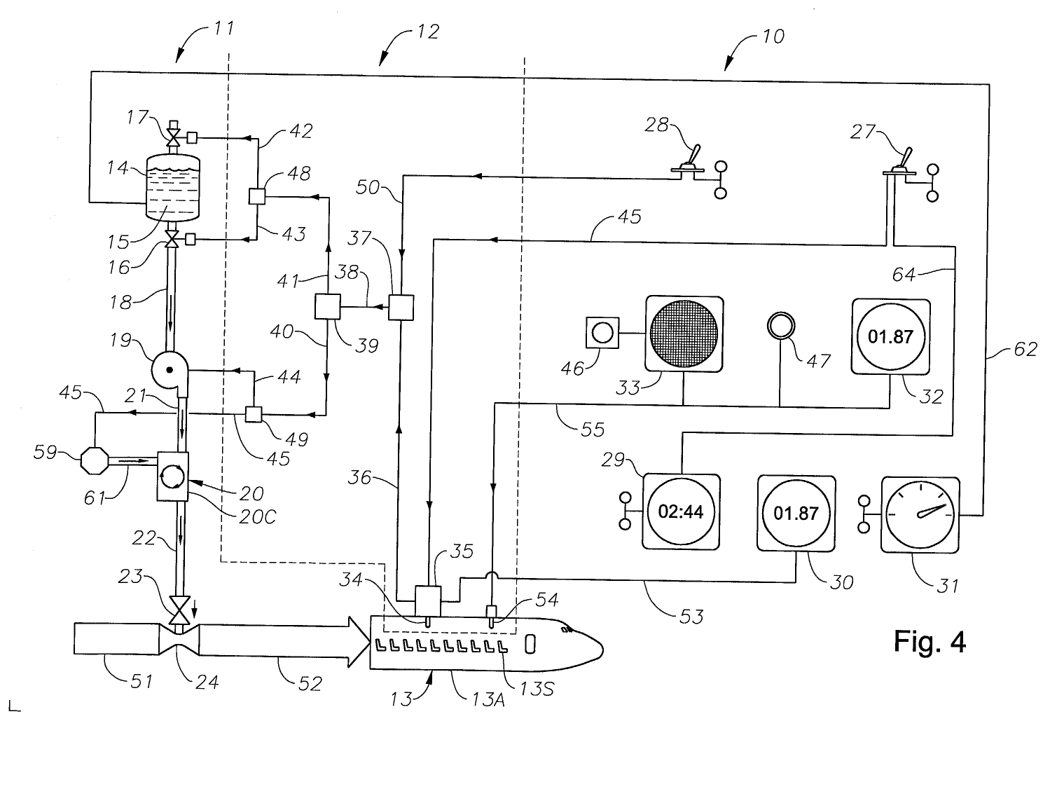

A further way of mixing and vaporizing the incapacitant substance 15 may be seen by reference to FIG. 4 wherein a state converter 20 is a gas activated vaporizer 20C but the gas source in this case is from an oxygen generator 59, which is activated by in put over line 45. In this case the oxygen generator 59 is supplied to generate a flow of oxygen gas for insertion into conduit 61 which is then delivered into the state converter 20. In this embodiment the accelerated oxygen gas flow from the oxygen generator 59 into the gas activated vaporizer 20C is used to vaporize the incapacitant substance 15 which is then deliver to conduit 22 which feeds from the gas activated vaporizer 20C. The vaporized incapacitant substance 15 and the oxygen gas is then delivered from the conduit 22 to the one way flow valve 23 and the mixing chamber 24 for delivery into the relatively confined space 13 of relatively know volume by way of duct 52 for the incapacitation of malfeasant and others.

As has been set out above, when incapacitant substance 15 reaches concentrations which are too high they may be harmful, while in appropriate concentrations they are merely incapacitants. Therefore it is important to control the concentration levels to achieve just temporary incapacitation but not harm to the malfeasant and others located in the relatively confined space 13 of a relatively known volume. Because in many uses of this invention the operator of the apparatus and method of this invention are generally removed or remote from the relatively confined space 13 of relatively known volume, it requires the operator to rely on controls to monitor the concentration and provide relatively safe incapacitation of the malfeasant and other in the relatively confined space 13. The appropriate sensor and controls interface 12, which may be located substantially outside of the relatively confined space 13, except for sensors, allows the operator to control the concentration even though he may be remote from where the relatively confined space 13 is located. Those sensors and controls, at least in this embodiment, are generally shown at the general reference number 12 in FIGS. 1, 2, 3 and 4, with the out put of those sensors and controls being delivered to instruments on the instrument panel 10. In the case of an air craft where the operator or pilot is in the cockpit and sealed off at least physically from the relatively confined space 13 of an air craft cabin 13A, in which a malfeasant and others are located, one way to provide monitoring and control is through a control panel 10, which has been generally referred to at reference number 10, and which would be located on the instrument panel in the cockpit of the air plane. It should be understood by those skilled in the art, that other and yet further controls and sensors and or instrument panels may be used without departing from the scope of this invention and further that wireless controls may be used in place of wired ones, but for the ease of description and understanding reference was herein made to lines as if wire lines are being used.

It should further be understood in the case of a pilot, operator, that the pilot would put on an oxygen mask which is connected to a separate oxygen supply before activating the apparatus and method of this invention to keep from incapacitating them selves, if their cockpit is not on a separate sealed air supply from the relatively confined space 13 of a relatively known volume. In the cockpit example above the pilot operator would have an instrument panel 10 for the activating this invention and then monitoring and controlling the effective concentration levels of incapacitant substance 15 for preventing the concentration levels of incapacitant substance 15 from reaching harmful levels but at the same time allowing concentrations sufficient for a given incapacitant substance 15 over a sufficient time period to incapacitate malfeasants and others in the relatively confined space 13 of relatively known volume.

To better understand the operation and interface between the operational apparatus 11, sensor and monitoring interface 12, and the instrument panel 10 reference may be made to FIGS. 1,2,3, and 4 which shows sensors and controller interfaces 12 between the instrument panel 10 and the operational apparatus 11 of this apparatus. These general references areas are marked off on FIGS. 1, 2, 3, and 4 using a dashed lines to show the general demarcation between sensor and controllers 12; instrument Panel 10; and operational apparatus 11, but these demarcation lines are only used for clarification in the understanding of this invention and are not part of the invention.

Referring first to the instrument panel 10 there is provided a switch member 27 for turning the apparatus and method of this system on and off and an emergency switch member 28 for over ridding all the systems and bringing the apparatus and method of this system to full dead stop. Then there is provided a system timer 29, for recording the elapsed time from activating the system until it is turned off; a first concentration indicator 30 for providing a read out of the concentration sensed in the relatively confined space 13; and then an incapacitant substance quantity indicator 31 for indicating the volume of incapacitant substance located in the tank 14. The incapacitant substance quantity indicator 31 is provided with a line 62 which connects to the tank 14 which allows for monitoring the quantity of incapacitant substance 15 in the tank at all times. Also on the instrument panel 10 is provided a second concentration indicator 32 as a back up to the first concentration indicator 30 and an audio indicator 33 which indicates the presence of any concentration of the incapacitant substance 15 in the relatively confined space 13, in this case of an air craft cabin 13A, by an audible warning that the incapacitant substance 15 is present or is becoming present in the air craft cabin 13A. The second concentration indicator 32 provides a back up reading of the incapacitant substance 15 to the first concentration indicator 30 as a fail safe redundancy. As with the case in most air plane instrumentations, a switch 46 is provided to override the audio indicator 33. Also provided on the instrument panel 10, which is common in air craft, is a warning light 47 for indicating the system has become activated and that incapacitant substance 15 is being delivered in the relatively confined space 13 or aircraft cabin 13A.

The instrument panel 10, as shown in FIGS. 1,2,3, and 4, is operatively connected to sensor and controllers interfaces 12 which provide a controlled interface between the instrument panel 10 and the operation apparatus 11. In the sensor and controller interface 12 of this embodiment there is provided a sensor member 34 mounted in the relatively confined space 13 or 13A for sensing the concentration of the incapacitant substance 15 mixed with a gas, which in this case is air, in the relatively known space 13 or 13A of relatively known volume of gas in which malfeasant and others are located. This sensor member 34 provides an out put signal to a controller member 35. The controller member 35 is connected over line 36 to an over ride controller relay 37, which is in turn connected over line 38 to a sequence relay 39. Also connected to relay 39 over line 50 is the emergency switch member 28. From relay 39 a connection is made by a pair of lines 40 and 41 to respective relays 48 and 49. A pair of lines 42 and 43 are connected to the relay 48 and then further connect to the one discharge valve 16 and vent actuator valve 17 mounted on the tank 14 for opening the tank 14 to allow flow of the incapacitant substance 15 into a conduit 18. A second pair of lines 44 and 45 are connected to the relay 49 and then further connected to the pump member 19 and the state converter 20, which in the case of FIG. 1 is a heat vaporizer 20A. The over ride emergency switch member 28 which is located on the instrument panel is connected to the controller relay 37 by line 50 to allow the complete system to be brought to a dead stop in the case of an emergency or if desired by the emergency switch 28 just being turned to the off position.

In at least some embodiments the controller member 35 in addition to just receiving an output signal from sensor member 34, after the controller member 35 has been actuated by the switch member 27 over line 45, the controller member 35 is provided with logic circuits for controlling flow of the incapacitant substance 15 which allows the concentration of incapacitate substance 15 and gas to be determined at least when a predetermined concentration has been reached sufficient for incapacitating a malfeasant and others located in the relatively confined space 13 of relatively known volume. Also provided in controller member 35 are logic circuits, not shown, for automatically activating the starting and stopping of movement of the incapacitate substance 15 in response to the concentration of said incapacitant substances being sensed below or exceeding the concentration of the incapacitant substance 15 and said gas sufficient for incapacitating a malfeasant and others in the relatively confined space 13 of relatively known volume. This logic circuit of controller member 35 also monitors the time duration for the level of concentration of the incapacitant substance 15 for providing incapacitation of a malfeasant and others in the relatively confined space 13 of relatively known volume

The operator or pilot in this example would in a real world event be made aware that a malfeasant or malfeasants were active in the air craft cabin 13A and then the pilot or other operators in the cockpit would put on their oxygen masks and activate the switch member 27 which is connected to the controller member 35 by line 45. Once the controller member 35 receives activating signal from switch member 27 then the controller member 35 sends an activation signal over line 36 through override controller relay 37 to sequence relay 39. The sequence relay 39 would then activate the relays 48 and 49 respectively which would in turn activate the one discharge flow valve 16 and the vent actuator valve 17 and the pump 19 to start the incapacitant substance 15 to commence movement from the tank 14 to the state converter 20 which in FIG. 1 a heat activated vaporizer 20A. Once the incapacitant substance 15 reaches the heat activated vaporizer 20A the incapacitant substance 15 would be converted to an air borne state and discharged from the heat activated vaporizer 20A into conduit 22 and through one way flow valve 23 to be mixed with the gas or air in this case in the mixing chamber 24, which as shown in this embodiment of FIG. 1 is a venture, and then passed into the relatively confined space 13 of relatively known volume.

While a heat activated vaporizer 20A may be used to vaporize incapacitant substance 15 FIG. 3 and FIG. 4 provide yet another way to vaporize the incapacitant substance 15. In FIG. 3 an intake valve 56 is connected to the main air-conditioning duct 51 for receiving gas from the main air-conditioning duct 51 and for delivering the gas through conduit 58 to state converter 20 for creating a vaporizing effect at its interface in the state converter 20 which in this case is a gas driven vaporizer 20B. After the Incapacitant substance 15 is vaporized in the gas driven vaporizer 20B it is discharged into conduit 22 for delivery through the one-way flow valve 23 which delivers the vaporized incapacitant substance 15 to the relatively confined space 13 of relatively known volume. In FIG. 4 an oxygen generator 59 is connected through conduit 61 for delivery of oxygen gas to the state converter 20 which in this case is an oxygen gas driven vaporizer 20C. After the incapacitant substance 15 is vaporized in the oxygen gas driven vaporizer 20C, it is discharged to conduit 22 for delivery through the one-way flow valve 23 which delivers the vaporized incapacitant substance 15 to the relatively confined space 13 of relatively known volume.

Once the incapacitant substance 15 is received into the relatively confined space 13, the concentration starts to build because the relatively confined space 13 is relatively confined as against loss of gas, in this case air, and it has a relatively known volume which can be calculated to allow the vaporizer's rate of vaporization to build an effective concentration of the incapacitant substance 13 to incapacitate malfeasants and others, even though the air-conditioning system is discharging from the relatively confined space 13 as the incapacitant substance 15 is being added. While the buildup of incapacitant substance 13 is occurring the sensor 34 connected to the control 35 begins to analyze the concentration in the relatively confined space 13 and to give out put over line 53 to first concentration indicator 30. Also at the same time as sensor 34 is giving out put over line 53, the second sensor 54 in the relatively confined space 13 of relatively known volume is giving output over line 55 to audio indicator 33 and second concentration indicator 32, and warning light 47. The output of the second sensor 54 is designed to make the pilot operator aware the system is operating by producing an audio sound in case he is not watching this system and to give the pilot operator a backup check against the reading of first concentration indicator 30 on the concentration levels of the incapacitant substance 15 in the relatively confined space 13 of relatively known volume. Also at the time the system was activated by switch member 27 the system timer 29 would be activated over line 64 so that the pilot operator would know how long the system has been operating and by way of incapacitant substance quantity indicator 31 the pilot operator would know the quantity of incapacitant substance 15 which would have flowed from tank 14. Therefore the instrument panel 10 is designed to give the pilot positive data on when the incapacitant substance 15 reaches a concentration level sufficient to incapacitate a malfeasant and others and the period of time over which such a level of concentration has been maintained so that the pilot will know that a malfeasant and others in the relatively confined space 13 of relatively known volume have become incapacitated.

It should be understood by those skilled in art that the concentration of airborne incapacitant substance 15 required for incapacitating a malfeasant and others may in a relatively confined space of relatively known volume will vary with the properties of the incapacitant substance 15. Also as those skilled in the art would be aware the incapacitant affects are also related to elapsed time of exposure to an incapacitant substance 15 and the concentration level of an incapacitant substance during that time period of exposure. Therefore a person would be incapacitated by either being exposed to an incapacitant substance at a relatively low level concentration of an incapacitant substance 15 over a relatively longer period of time or a person would be incapacitated by an incapacitant substance at a relatively high concentration over a relatively short period of time. These concentrations levels and periods of time would be different based on the different properties for given incapacitant substance 15.

To further teach those skilled in the art how to use the apparatus and methods of this invention at least one specific embodiment using the anesthetic Sevorane®, a proprietary and trademarked anesthetic of Abbott Laboratory Ltd. composed generally of a fluoromethyl 2,2,2-trifluoro-a-(trifluoromethyl) ethyl ether will be used. This particular anesthetic has been shown to be effective for incapacitation of both animals and humans, and it has the added benefits that it is not flammable or corrosive, which is especially important for aircraft applications of this invention.

In this embodiment using Sevorane® in a air craft as shown in FIG. 1 the tank 14 would be filled with Sevorane® and the pilot would know that the tank 14 is full because the tank 14 level would be transmitted over line 62 to the incapacitant substance quantity indicator 31 located on the instrument panel 10 located in the cockpit. This check of incapacitant fluid level would just be another check off procedure for the pilot and flight crew before take off like all the others they would go through before take. After take off if a passenger declared himself a malfeasant then as soon as the pilot became aware that the passenger had declared himself a malfeasant the pilot would put on his oxygen mask and advise the other cockpit crew to do the same. Once all the oxygen masks are on then the pilot would throw the switch member 27, which is the initial activation switch to activate the system. The switch member 27 would send a signal to the system timer 29 over line 64 and to the controller member 35 over line 45 to begin the activation and monitoring sequence of the system. Upon the controller member 35 being activated it would send out put to the over ride controller relay 37 over line 36 which would in turn send out put over line 38 to sequence relay 39. The sequence relay 39 would then forward out put by way of lines 41 and 40 to relays 48 and 49. The relay 48 then further forwards out put to the one discharge valve 15 to open that valve and to vent actuator valve 17 to open that valve, such that the flow from tank 14 may commence. At about the same time relay 49 would then forward out put to the pump member 19 and the state converter 20, which in this FIG. 1 embodiment is a heat activated vaporizer 19A. Once the pump member 19 receives the out put it begins pumping which draws the incapacitant substance 15 by way of conduit 18 from the tank 14 and discharges it into conduit 21 which feed into the heat activated vaporizer 19A for vaporization. One of the benefits of using a pump member 20 to feed the heat vaporizer 20A is that a controlled feed under a constant pressure can be achieve for consistent delivery of incapacitant substance 15 to the heat vaporizer 19A which allows the heat vaporizer 19A to give a controlled and consistent out put of the vaporized incapacitant substance 15, which in this case is Sevorane®. Once the incapacitant substance 15 is vaporized it is discharged into conduit 22 which then feeds to one way flow valve 23 which would be opened once the pressure of the incapacitant substance 15 reaches a pressure sufficient to positively open the one way flow valve 23 for discharge into a mixing chamber 24, which in this case is a venture type. At the same time the incapacitant substance 15 is being discharged into the mixing chamber 24 the main air conditioning duct 51 which is connected to the mixing chamber 24 is driving air there through and on into the relatively contained space 13, which in this case is the air craft cabin 13A. As soon as sensors 34 and second sensor 54 are able to sense the presence of the incapacitant substance 15 in the aircraft cabin 13A an out put is given by sensor 34 and second sensor 54. The out put from second sensor 54 is given by line 55 to audio indicator 33 for an audio sound being made in the cockpit to alert the pilot that the incapacitant substance 15 is present in the air craft cabin 13A. Further the out put from sensor 54 is given by line 55 to warning light 47 as a further indicator that the incapacitant substance is present. It should be appreciated also that both this audio indicator 33 and warning light 47 may be used as a safety device to also alert the pilot of the presence of the incapacitant substance 15 being present in the cabin in case of a malfunction also, so that the pilot could take preventive measure before becoming incapacitated. The out put from sensor 34 is further feed to second concentration indicator 32 which begin to give a digital read out of the percent concentration of the incapacitant substance 15 which is beginning to become present in the air craft cabin 13 A.

The senor 34 begins giving out put signals but this signal also goes to controller member 35 which gives out put to first concentration indicator 30, which begins to give digital read out of the percent concentration of the incapacitant substance 15 as it is beginning to become present in the air craft cabin 13A. This first concentration indicator 30 give a digital read out on the instrument panel 10 and gives the pilot a back up reading of Sevorane® percent concentration against the second concentration indicator 32 as a fail safe. While the pilot could manually control the concentration by watching the first and second concentration indicators 30 and 32 and then switch off the system by throwing the switch member 27 off when the concentration of Sevorane® exceeds 8% and then switch on the system by throwing the switch member 27 on when the concentration of Sevorane® drops below 8%, this activity would be very time intensive for a pilot and would best be left to automatic monitoring. Therefore the sensor 34 also send out put to the controller member 35 for input to its logic circuits which have been programmed to control the concentration of the incapacitant substance 15, in the case of Sevorane®, to a maximum concentration of 8% in the air craft cabin 13A. The controller member 35 achieves this control of Sevorane® in the air craft cabin 13A by automatically starting and stopping the movement of Sevorane® in response to the concentration being below or exceeding the predetermined up side limit of the 8% with out put through line 36 to the rest of the system already described for starting and stopping the movement of Sevorane® from the tank 14 to the heat vaporizer 20A and into the air craft cabin 13A.

It will be remembered from the above description that at the same time the pilot activates the switch member 27 which started the flow of Sevorane® into the system that the system timer 29 was also activated over line 64 and this is important whether the pilot or the controller member 35 is controlling the system. The reason that it is important is the any incapacitant substance 15 whether Sevorane® or any other cause incapacitance over time depending on their concentration, therefore any incapacitant substance which is used will have to have it concentration monitored against the time of it exposure to malfeasants and others. In the case of Sevorane® a concentration in excess of 2% and less than 8% over a time period from commencement of flow up to 10 minutes has been found to be effective to incapacitate humans. It would however be apparent to those skilled in the art that a lower concentration over a longer period may be effect while a higher concentrations at a shorter time may be effective for incapacitation of malfeasants, but there is some risk of injury at higher concentrations.

While the above embodiment and much of the description has been about the relatively confined space 13 of an air craft cabin 13A, it will be understood by those skilled in the art that this invention could be used in many other environments. For example in the situation of riots in a prison system, if such a system was put in place in cell blocks, then at the first instance of a riot the operator, a warden in this case, would activate the apparatus and methods of this system and all the others as well as the malfeasant who might have started the riot would be incapacitated and the destruction which may normally occur to the prison would be averted. Further if some of the others were hostages such as prison guards then injury may be prevented to the guards and there would not be any need for prolonged hostage negotiations. While the apparatus and methods used in a prison environment may require more incapacitant substance 15, the need for multiple back up and fail safe systems may not be so important as the operator may be a better position to observe the effects of incapacitation.

Also other embodiments may be used as for the example the prevention of hostages being taken during a financial institution robbery. Instead of putting customers and bank personnel at risk of being injured in shoot out the bank officer could activate the apparatus and methods of this invention and incapacitate all the malfeasants and others. The apparatus and method for deliver of the incapacitant substance 15 might be through the air conditioning ducts of a financial institution.

Yet another valuable application of the apparatus and method of this invention would be in police hostage stand off situations where the apparatus and method might limit the need for a shoot out by a SWAT team with the malfeasant, hostage takers in this case. In this application the apparatus and methods of this invention would be mounted on portable chassis which could be towed to a relatively confined space and a calculation of the relative volume could be made to determine the quantity of incapacitant substance 15 which would be required to reach a level sufficient to incapacite a malfeasant and others located in the relatively confined space 13 with the calculated volume. As those skilled in the art might appreciate the duct 52 might have to modified to a long hose for deliver of the incapacitant substance 15 to the relatively confined space 13 and the sensors 34 and second sensor 54 if needed may have to be mounted on extendable lines, but the operation and effectiveness of such an embodiment would none the less be effective. Clearly the apparatus and methods of such a portable embodiment of this invention and it included teachings would be within the scope of this invention and easily usable by those skilled in the art with only minor trial and error for the particular application to be effective.

While the preferred embodiments of the apparatus of this invention and their inventive methods of use have been described for temporarily incapacitating a malfeasant and others located in a relatively confined space of relatively known volume, it will be appreciated that other embodiments and methods may be used without departing from the spirit, scope, or teachings of the invention.

I claim:

1. A method for temporarily incapacitating a malfeasant and others located in a relatively confined space of relatively known volume comprising;
holding an incapacitant substance in a container,
moving said incapacitant substance out of said container,
converting said incapacitant substance to be air borne, and
distributing said air borne incapacitant substance into a relatively confined space of relatively know volume until said malfeasant and others are temporarily incapacitated.

2. The method of claim 1 further comprising:
activating a value to open said container holding said incapacitant substance.

3. The method of claim 2 further comprising;
receiving said incapacitant substance as said incapacitant substance is moved out of said container,
vaporizing said incapacitant substance into an air borne state, and
mixing said air borne incapacitant substance with a gas in said relatively confined space of relatively know volume until malfeasant and others are temporarily incapacitated.

4. The method of claim 3 further comprising;
monitoring said concentration of said incapacitant substance mixed with said gas in said relatively confined space of relatively know volume, and
controlling said vaporization of said incapacitant substance in response to said monitoring of said concentration of the said incapacitant substance in said gas in said relatively confined space of relatively know volume until malfeasant and others are temporarily incapacitated.

5. The method of claim 4 further comprising;
flowing said vaporized incapacitant substance away as said incapacitant substance is vaporized, and
preventing said vaporized incapacitant substance from back flow.

6. The method of claim 5 further comprising;
sensing said concentration of said incapacitant substance in said gas in said relatively confined space of relatively know volume,
providing an out put indication of said concentration of said incapacitant substance sensed,
transmitting said out put indication of said concentration of said incapacitant substance to a controller, and
controlling said concentration of said incapacitant substance converted into an air borne state in response to said sensed concentration to at least a sufficient concentration for incapacitating a malfeasant and others located in said relatively confined space of relatively known volume.

7. The method of claim 6 further comprising;
providing a visual signal from said out put indication of said concentration being sensed to monitor the concentration of incapacitant substance and said gas to determine at least a predetermined concentration of said incapacitant substance and said gas has been reached sufficient for incapacitating a malfeasant and others located in said relatively confined space of relatively known volume.

8. The method of claim 7 further comprising;
controlling an anesthetic incapacitant substance to at least a sufficient concentration for incapacitating said malfeasant and others located in said relatively confined space of relatively known volume.

9. The method of claim 8 wherein said controlling said anesthetic incapacitant substance further comprises further;
controlling an anesthetic incapacitant substance of Fluoromethyl 2,2,2,-Trifluoro-1 (Trifluoro Methyl) Ethyl Ether to at least a sufficient concentration for incapacitating said malfeasant and others located in said relatively confined space of relatively known volume.

10. The method of claim 9 wherein said controlling of said concentration of said anesthetic incapacitant substance of said Fluoromethyl 2,2,2,-Trifluoro-1 (Trifluoro Methyl) Ethyl Ether further comprises;
controlling said Fluoromethyl 2,2,2,-Trifluoro-1 (Trifluoro Methyl) Ethyl Ether from 2% to 8% concentration for incapacitating said malfeasant and others located in a confined space of relatively known volume.

11. The method of claim 10 wherein said controlling of said Fluoromethyl 2,2,2,-Trifluoro-1 (Trifluoro Methyl) Ethyl Ether from 2% to 8% concentration further comprises;
controlling said Fluoromethyl 2,2,2,-Trifluoro-1 (Trifluoro Methyl) Ethyl over a time period from commencing flow of said Fluoromethyl 2,2,2,-Trifluoro-1 (Trifluoro Methyl) Ethyl Ether up to 10 minutes for incapacitating said malfeasant and others located in said relatively confined space of relatively known volume.

12. The method of claim 7 further comprising;
providing an audio signal from said out put indication of any concentration of said incapacitant substance being sensed for an operator to know that said concentration of said incapacitant substance and said gas is present in said relatively confined space of relatively known volume.

13. The method of claim 12 further comprising;
providing an activation switch to allow said operator to start and stop said movement of said incapacitant substance.

14. The method of claim 13 further comprising;
automatically controlling said activation switch for starting and stopping said movement of said incapacitant substance in response to said concentration of said incapacitant substance being below or exceeding at least a concentration of said incapacitant substance and said gas sufficient for incapacitating said malfeasant and others in said relatively confined space of relatively known volume.

15. The method of claim 14 further comprising;
providing an emergency shut off switch to over ride said activation switch and shut down all movement of incapacitant substance.

16. The method of claim 15 further comprising;
timing said flow of said incapacitant substance from its commenced flow until said concentration of said incapacitant substance and said gas has been sufficient for incapacitating a malfeasant and others in said relatively confined space of relatively known volume.

17. The method of claim 16 further comprising;
monitoring said concentration of said incapacitant substance and said gas at a concentration level at least sufficient for incapacitating a malfeasant and others in said relatively confined space of relatively known volume, and
timing said duration of said level of concentration at least sufficient for incapacitating a malfeasant and others in said relatively confined space of relatively know volume for being sure that said malfeasant and said others are incapacitated.

18. The method of claim 17 further comprising;
monitoring the quantity of said incapacitant substance being held in said container for allowing said operator to know that sufficient incapacitant substance is in the tank to reach a level sufficient for incapacitating a malfeasant and other and for holding said level for a sufficient time to be sure that said malfeasant and said others are incapacitated in said relatively confined space of relatively known volume.

19. The method of claim 18 further comprising;
sensing with a sensor located in said relatively confined space of relatively known volume the concentration of said incapacitant substance and said gas for out putting a signal in response to said concentration sensed exceeding at least a concentration of incapacitant substance and said gas sufficient for incapacitating a malfeasant and others in said relatively confined space of relatively known volume and,
automatically switching off said activation switch in response to said out putting signal from said sensor when said concentration of said incapacitant substance and said gas exceeds at least a concentration of incapacitant substance and said gas for incapacitating said malfeasant and others in said relatively confined space of relatively known volume.

20. Apparatus for temporarily incapacitating a malfeasant and others located in a relatively confined space of relatively known volume comprising;
a relatively confined space member of relatively known volume of gas in which said malfeasant and other are located,
an incapacitant substance for incapaciting malfeasant and others,
a tank member for holding said incapacitant substance and having at least a discharge valve for allowing movement of said incapacitant substance out of said tank member, and
a state converter member for receiving said incapacitant substance from said tank member and for converting said incapacitant substance into a state to be air borne and for discharging said state converted incapacitant substance into said relatively confined space member in which said malfeasant and other are located for temporarily incapacitating said malfeasant and others.

21 The method of claim 20 further comprising;
a pump member for moving said incapacitant substance from said tank member through said discharge valve to said state converter member.

22. The method of claim 21 further comprising;
one way flow valve connected in communication with said state converter member for allowing said incapacitant substance in said air borne state to pass for mixing with said gas in said relatively confined space member and for preventing back flow.

23. The apparatus of claim 22 further comprising;
a mixing chamber for receiving said state converted incapacitant substance for mixing said incapacitant substance with said gas for distribution into said confined space member of a relatively known volume until said malfeasant and others are temporarily incapacitated.

24. The apparatus of claim 23 further comprising;
a forced gas member for driving additional gas into said mixing chamber for increased mixing of said incapacitant substance with said gas for distribution into said relatively confined space member of a relatively known volume until said malfeasant and other are temporarily incapacitated.

25. The apparatus of claim 24 further comprising;
a sensor member mounted for sensing said concentration of said incapacitant substance mixed with said gas in said relatively confined space of relatively known volume in which malfeasant and others are located and providing an out put signal, and
a monitor member for receiving said output signal for said sensed concentration of said incapacitant substance from said sensor member, and
a controller member for adjusting said amount of incapacitant substance which is converted to a state to be air borne and discharged into said relatively confined space member in which said malfeasant and others are located for temporarily incapacitating said malfeasant and others.

26. The apparatus of claim 25 further comprising;
an indicating member connected to said monitor members for giving a read out of said out put signal of said concentration of said incapacitant substance and gas mixture in said space of relatively know volume in which malfeasant and others are located.

27. The of claim 26 wherein said indicating member connected to said monitor members further comprises;
a visual read out member for displaying said concentration being sensed for allowing an operator to monitor said concentration of said incapacitant substance and gas mixture to determine that at least a sufficient concentration has been reached for incapacitating a malfeasant and others located in said confined space of relatively known volume.

28. The apparatus of claim 27 wherein said indicating member connected to said monitor members further comprises;
an audio signal member for indicating the presence of said incapacitant substance being sensed for an operator to know that said incapacitant substance and gas mixture are present in said relatively confined space of relatively known volume.

29. The apparatus of claim 28 further comprising;
a switch member for allowing said operator to start and stop said pump member and said state converter member.

30. The apparatus of claim 29 further comprising;
an automatic switch controller member for controlling said concentration of said incapacitant substance and said gas in response to said concentration being below or exceeding said at least concentration of said incompacitant substance and said gas sufficient for incapaciting said malfeasant and others in said relative confined space of relatively known volume.

31. The apparatus of claim 30 further comprising;
an emergency switch member for over riding said switch member to stop said pump member and said state converter member.

32. The apparatus of claim 31 further comprising;
a sufficient quantity of incapacitant substance for being made air borne and mixed with said gas for achieving a concentration of said incapacitant substance and said gas over a period of time at least sufficient to incapacitate a malfeasant and others located in said relatively confined space of relatively known volume to allow said malfeasant to be restrained.

33. The apparatus of claim 32 wherein said incapacitant substance further comprises;
an anesthetic substance.

34. The apparatus of claim 33 wherein said anesthetic substance further comprises;
Fluoromethyl 2,2,2,-Trifluoro-1 (Trifluoro Methyl) Ethyl.

35. The apparatus of claim 34 wherein said Fluoromethyl 2,2,2,-Trifluoro-1 (Trifluoro Methyl) Ethyl further comprises;
a concentration of said Fluoromethyl 2,2,2,-Trifluoro-1 (Trifluoro Methyl) Ethyl Ether from 2% to 8% in said relatively confined space of relatively known volume over a time period from commencement of flow to 10 minutes.

36. The apparatus of claim 35 wherein said relatively confined space member of relatively known volume of gas in which said malfeasant and others are located further comprises;
an aircraft cabin.

37. The apparatus of claim 36 wherein said relatively confined space member of relatively known volume of gas in which said malfeasant and others are located further comprises;
a cell block in a penal institution.

38. The apparatus of claim 37 wherein said relatively confined space member of relatively known volume of gas in which said malfeasant and others are located further comprises;
a public area of a financial institution.

39. The apparatus of claim 24 further comprises;
a portable chassis body for mounting said apparatus for movement to a space of calculable known volume of gas in a relatively confined space in which said malfeasant and others are located and for incapacitating said malfeasant and others located in said relatively confined space of calculated relatively known volume.
